(19) United States
(12) Patent Application Publication
(10) Pub. No.: US 2022/0312211 A1
(43) Pub. Date: Sep. 29, 2022

(54) SYSTEM AND DEVICE FOR VERIFYING FUNCTION OF RADIO BASE STATION

(71) Applicant: FUJITSU LIMITED, Kawasaki-shi (JP)

(72) Inventor: Kenji ARAI, Yokohama (JP)

(73) Assignee: FUJITSU LIMITED, Kawasaki-shi (JP)

(21) Appl. No.: 17/533,218

(22) Filed: Nov. 23, 2021

(30) Foreign Application Priority Data
Mar. 26, 2021 (JP) 2021-053394

(51) Int. Cl. H04W 12/102; H04W 12/50; H04W 24/06

(52) U.S. Cl. CPC H04W 12/102; H04W 12/50; H04W 24/06

(57) ABSTRACT

A verification system verifies a signal processor unit and a radio unit. The verification system includes a pseudo radio unit and a pseudo signal processor unit. The pseudo radio unit includes a first processor that executes a connection sequence with the signal processor unit, acquires a first sequence log indicating an execution result of a connection sequence between the pseudo signal processor unit and the radio unit, and executes a connection sequence with the signal processor unit based on the first sequence log. The pseudo signal processor unit includes a second processor that executes a connection sequence with the radio unit, acquires a second sequence log indicating an execution result of a connection sequence between the pseudo radio unit and the signal processor unit, and executes a connection sequence with the radio unit based on the second sequence log.

### CROSS-REFERENCE TO RELATED APPLICATION

This application is based upon and claims the benefit of priority of the prior Japanese Patent Application No. 2021-053394, filed on Mar. 26, 2021, the entire contents of which are incorporated herein by reference.

### FIELD

The embodiments discussed herein are related to a system and a device for verifying a function of a radio base station.

### BACKGROUND

The architecture of the base station is studied in the O-RAN (Open-Radio Access Network) Alliance. For example, in the fronthaul specification, the functions of the base station are separated into O-DU (O-RAN Distributed Unit) and O-RU (O-RAN Radio Unit). The O-DU provides the function of processing the signal in the base station. Meanwhile, the O-RU is equipped with a radio transceiver and provides the function of transmitting radio signals and the function of receiving radio signals. Therefore, the O-DU is an example of the signal processor unit that processes signals in the base station. Meanwhile, the O-RU is an example of the radio unit that transmits and receives radio signals.

FIGS. 1A-1C illustrate an example of a method for verifying the connection between an O-DU and an O-RU. When connecting an O-DU and an O-RU, first, the operation of the O-DU and the O-RU is verified individually. That is, as illustrated in FIG. 1A, an RU simulator 202 is connected to an O-DU 101. The RU simulator 202 is designed to perform the same operation as the O-RU. Accordingly, whether or not the O-DU 101 operates in the normal manner is verified. Meanwhile, as illustrated in FIG. 1B, a DU simulator 201 is connected to an O-RU 102. The DU simulator 201 is designed to perform the same operation as the O-DU. Accordingly, whether or not the O-RU 102 operates in the normal manner is verified. In the case in which the O-DU 101 and the O-RU 102 operate in the normal manner, as illustrated in FIG. 1C, the operation is verified in the state in which the O-DU 101 and the O-RU 102 are connected to each other.

Meanwhile, WO2020/217989 discloses the 5G-gNB (5th generation base station) that is studied by the O-RAN Alliance.

Although the simulator (201, 202) illustrated in FIG. 1A or 1B is designed to comply with O-RAN specifications, it is difficult to perfectly reproduce the behavior of the O-DU or the O-RU. For example, the response timing of a message or the value of a parameter according to a simulator may differ from the actual O-DU or O-RU. Therefore, even when the respective operation of the O-DU and the O-RU is normal according to the test using the simulator, problems may occur when the O-DU and the O-RU are actually connected.

In addition, since the base station architecture described above is made open, the O-DU and the O-RU may be provided by different vendors. Then, in the case in which the O-DU and the O-RU are provided by different vendors, the vendor of one of the units is often unable to obtain the design document of the other unit, and problems are prone to occur due to the lack of understanding of the detailed operations. Furthermore, in the case in which each vendor develops the unit in a different country, the time required to establish an environment for verification becomes longer, which may delay the identification of problems.

### SUMMARY

According to an aspect of the embodiments, a verification system verifies a connection between a signal processor unit of a radio base station and a radio unit of a radio base station. The verification system includes: a pseudo radio unit connected to the signal processor unit; and a pseudo signal processor unit connected to the radio unit. The pseudo radio unit includes a first processor configured to execute a connection sequence with the signal processor unit, acquire a first sequence log that indicates an execution result of a connection sequence between the pseudo signal processor unit and the radio unit, and execute a connection sequence with the signal processor unit based on the first sequence log. The pseudo signal processor unit includes a second processor configured to execute a connection sequence with the radio unit, acquire a second sequence log that indicates an execution result of a connection sequence between the pseudo radio unit and the signal processor unit, and execute a connection sequence with the radio unit based on the second sequence log.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A-1C illustrate an example of a method for verifying the connection between the O-DU and the O-RU;

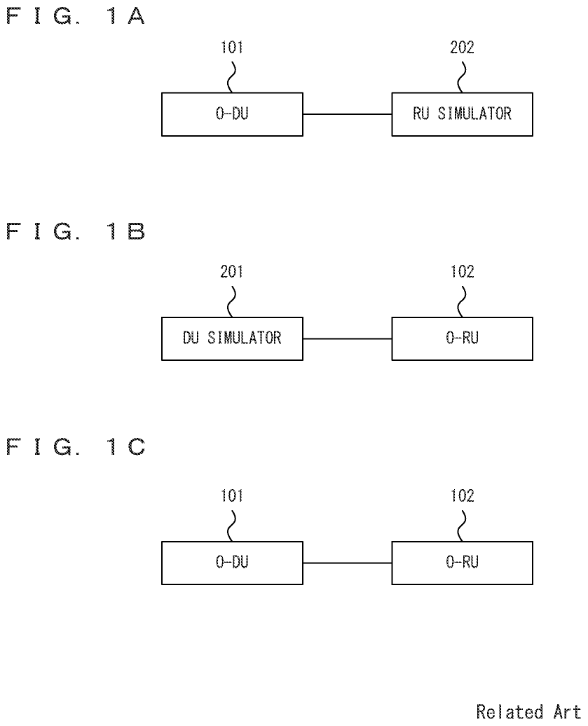

FIG. 2 illustrates an example of the architecture of a base station device;

FIG. 3 illustrates an example of the fronthaul between the O-DU and the O-RU;

FIG. 4 illustrates an example of the startup sequence for establishing an M-plane connection;

FIG. 5 illustrates an example of a verification system according to an embodiment of the present invention;

FIGS. 6A and 6B illustrate an example of a sequence log;

FIG. 7 illustrates an example of a pseudo radio unit (P-RU);

FIG. 8 illustrates an example of a pseudo signal processor unit (P-DU);

FIGS. 9A-9C illustrate an example of a method for verifying the operation of a signal processor unit;

FIGS. 10A-10C illustrate an example of a method for verifying the operation of a radio unit;

FIG. 11 illustrates an example of the operation of a verification system;

FIGS. 12A-12C illustrate an example of S10 in FIG. 11;

FIG. 13 is a flowchart illustrating an example of the processing of a pseudo signal processor unit (P-DU); and

FIG. 14 is a flowchart illustrating an example of the processing of a pseudo radio unit (P-RU).

### DESCRIPTION OF EMBODIMENTS

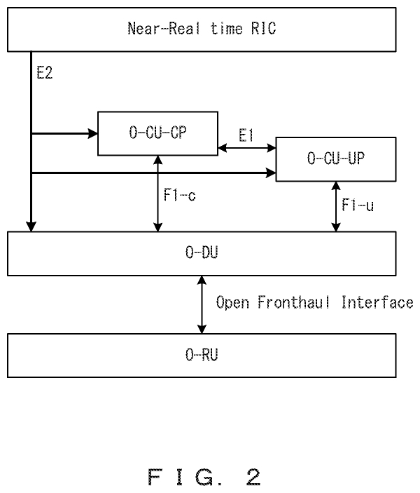

FIG. 2 illustrates an example of the architecture of a base station device. The architecture illustrated in FIG. 2 is defined by the O-RAN Alliance.

The base station defined in the O-RAN Alliance is equipped with RIC (Near-Real time RAN Intelligence Controller), O-CU-CP (O-RAN Central Unit Control Plane), O-CU-UP (O-RAN Central Unit User Plane), O-DU (O-RAN Distributed Unit), and O-RU (O-RAN Radio Unit). The verification system verifies the connection between the O-DU and the O-RU. Meanwhile, the open fronthaul interface between the O-DU and the O-RU has been studied in the Working Group 4 (WG4) of the O-RAN Alliance.

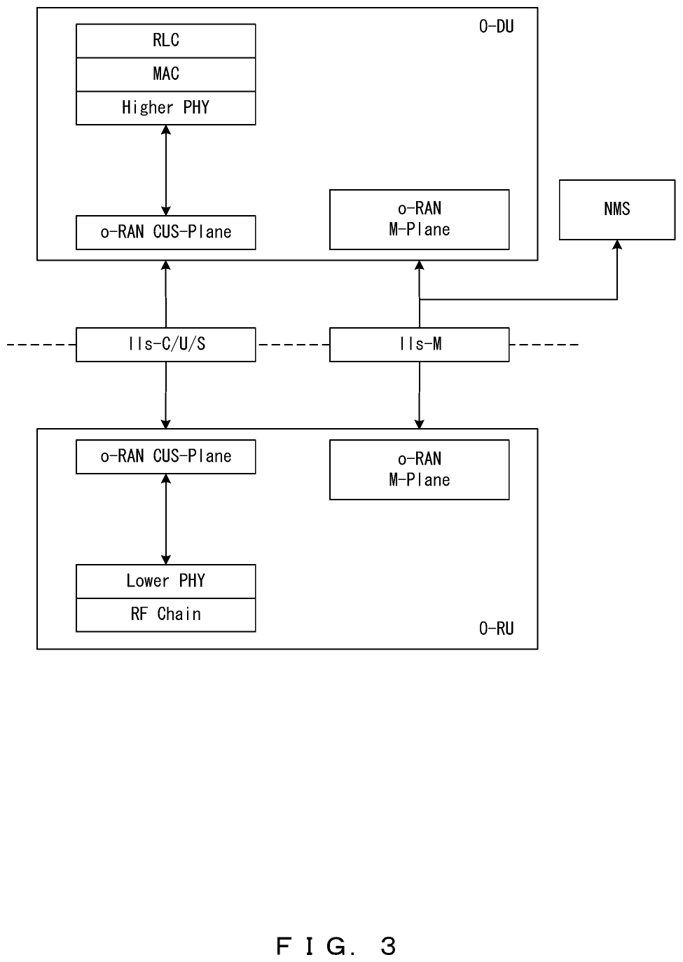

FIG. 3 illustrates an example of the fronthaul between the O-DU and the O-RU. The function of the fronthaul illustrated in FIG. 3 is specified by the Working Group 4 of the O-RAN Alliance.

The communication between the O-DU and the O-RU is realized using the C (Control)-plane, U (User)-plane, S (Synchronization)-plane, and M (Management)-plane. The C-plane carries control signals. The U-plane carries user data. The S-plane carries synchronization signals. The M-plane carries management signals. Here, the M-plane is realized by the Hierarchical model where the O-RU is managed by the O-DU, or the Hybrid model where the O-RU is managed by the O-DU and the Network Management System (NMS). The verification system according to an embodiment of the present invention is applied to the connection in the M-plane in the Hierarchical model.

In the M-plane, a protocol stack that transmits NETCONF (Network Configuration protocol) signals via Ethernet (registered trademark)/TCP/IP/SSH (Secure Shell) is supported. NETCONF is specified by the Internet Engineering Task Force (IETF) as RFC6241 and is used to manage network devices.

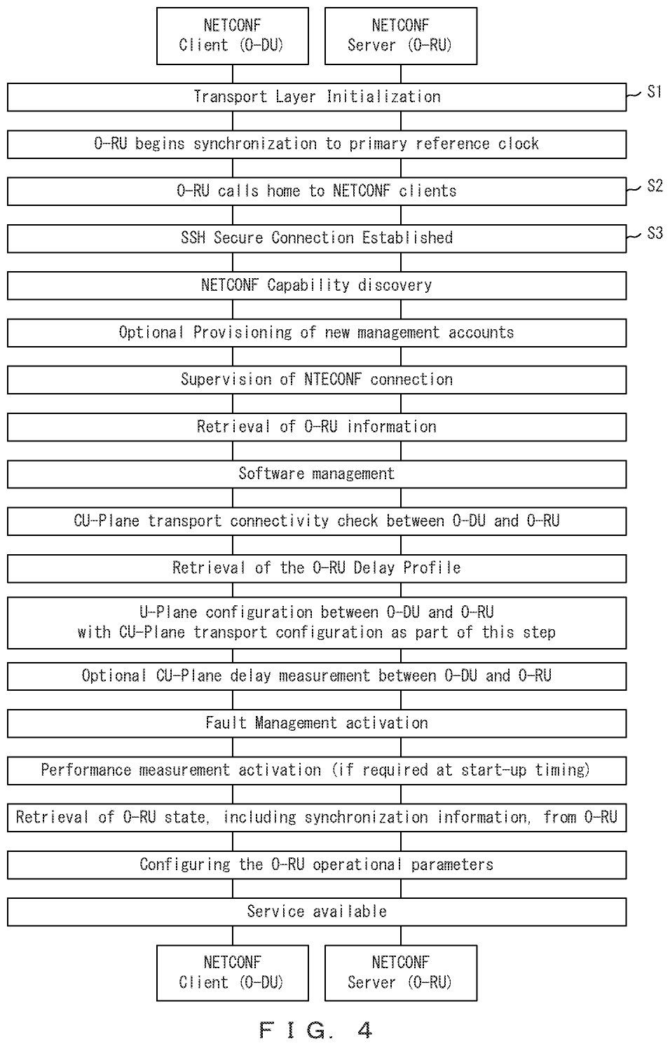

FIG. 4 illustrates an example of a startup sequence for establishing an M-plane connection at the time of starting/restarting the O-RU. For example, in S1, information such as the IP address is assigned to the network by DHCP. In S2, a TCP session is established between the O-DU and the O-RU. In S3, an SSH secure connection is established. In this startup sequence, the O-DU operates as the NETCONF client, and the O-RU operates as the NETCONF server. In addition, this sequence may also be referred to as Start-up Installation. Then, after the startup sequence is completed, the O-RU can transmit and receive radio signals.

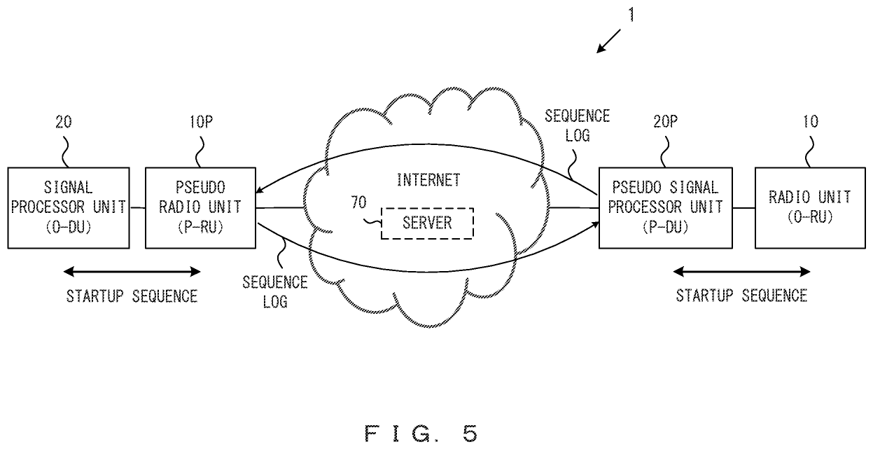

FIG. 5 illustrates an example of a verification system for a base station according to an embodiment of the present invention. A signal processor unit 20 corresponds to the O-DU (O-RAN Distributed Unit) illustrated in FIG. 2 or FIG. 3. A radio unit 10 corresponding to the O-RU (O-RAN Radio Unit) illustrated in FIG. 2 or FIG. 3. The signal processor unit 20 and the radio unit 10 may be manufactured by the same vendor or by different vendors.

It is preferable that the operations of the signal processor unit 20 and the radio unit 10 are individually verified before being implemented in a radio base station. However, for example, when the signal processor unit 20 and the radio unit 10 are manufactured by different vendors, it may be difficult to verify the operations of the signal processor unit 20 and the radio unit 10 in the state in which they are connected with each other. Therefore, a verification system 1 according to an embodiment of the present invention verifies the operation of the signal processor unit 20 and the radio unit 10 without connecting the signal processor unit 20 and the radio unit 10 to each other.

The verification system 1 includes a pseudo radio unit 10P and a pseudo signal processor unit 20P, as illustrated in FIG. 5. The pseudo radio unit 10P is a pseudo communication device (or a radio unit simulator) designed to perform substantially the same operation as the radio unit 10. Therefore, in the following description, the pseudo radio unit 10P may be referred to as “P-RU (Pseudo-Radio Unit).” Also, the pseudo signal processor unit 20P is a pseudo communication device (or a signal processor unit simulator) designed to perform substantially the same operation as the signal processor unit 20. Therefore, in the following description, the pseudo signal processor unit 20P may be referred to as a “P-DU (Pseudo-Distributed Unit).”

Here, the signal processor unit 20 and the radio unit 10 execute a startup sequence in the M-plane when they are implemented in the radio base station. For example, the startup sequence illustrated in FIG. 4 is executed. Then, when the startup sequence is completed, the radio base station starts transmission and reception of radio signals. Therefore, the verification system 1 executes the startup sequence using the pseudo radio unit 10P and the pseudo signal processor unit 20P. Specifically, the pseudo radio unit 10P executes the startup sequence with the signal processor unit 20. Also, the pseudo signal processor unit 20P executes the startup sequence with the radio unit 10. Meanwhile, the connections between the pseudo radio unit 10P and the signal processor unit 20 and the connection between the pseudo signal processor unit 20P and the radio unit 10 are respectively made by eCPRI (registered trademark).

The pseudo radio unit 10P executes the startup sequence with the signal processor unit 20. Then, the pseudo radio unit 10P generates a sequence log that indicates the result of the startup sequence.

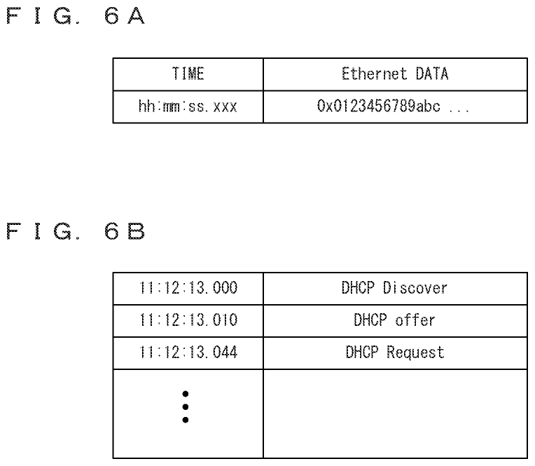

FIGS. 6A and 6B illustrate an example of a sequence log. The sequence log is generated in a format specified in advance. In this example, the sequence log consists of “Time” and “Ethernet Data” as illustrate in FIG. 6A. The “Time” represents the time when the message is sent or received. The “Ethernet Data” represents the message that is sent or received. For example, in the example in FIG. 6B, a DHCP Discover is sent at 11:12:13.000, a DHCP Offer is received at 11:12:13.010, and a DHCP Request is sent at 11:12:13.044.

The pseudo radio unit 10P transmits the generated sequence log to the pseudo signal processor unit 20P. In this case, the sequence log is transmitted from the pseudo radio unit 10P to the pseudo signal processor unit 20P via the Internet, for example. Then, the pseudo signal processor unit 20P receives the sequence log generated by the pseudo radio unit 10P. Alternatively, the pseudo radio unit 10P may store the generated sequence log in a server 70. In this case, the pseudo signal processor unit 20P acquires the sequence log generated by the pseudo radio unit 10P from the server 70.

The pseudo signal processor unit 20P executes the startup sequence with the radio unit 10. At this time, the pseudo signal processor unit 20P executes the startup sequence based on the sequence log generated by the pseudo radio unit 10P. Then, it is determined whether this sequence is executed in the normal manner or not. For example, if the startup sequence is completed successfully, it is determined that the radio unit 10 is normal. On the other hand, if the startup sequence is not completed successfully, it is determined that the radio unit 10 is not normal.

Here, the sequence log generated by the pseudo radio unit 10P indicates the result of the actual execution of the startup sequence between the pseudo radio unit 10P and the signal processor unit 20. Therefore, if the pseudo signal processor unit 20P executes the startup sequence based on the sequence log generated by the pseudo radio unit 10P, the operation of the pseudo signal processor unit 20P will be the same or almost the same as the operation of the signal processor unit 20, that is, the pseudo signal processor unit 20P can simulate the operation of the signal processor unit 20 with good accuracy. Therefore, without directly connecting the signal processor unit 20 and the radio unit 10, the operation of the radio unit 10 may be accurately verified using the pseudo signal processor unit 20P.

In a similar manner, the pseudo signal processor unit 20P executes the startup sequence with the radio unit 10 and generates a sequence log that indicates the result of the execution. Meanwhile, the pseudo radio unit 10P executes the startup sequence based on the sequence log generated by the pseudo signal processor unit 20P. Then, it is determined whether or not this sequence is executed in the normal manner.

Here, the sequence log generated by the pseudo signal processor unit 20P indicates the result of the actual execution of the startup sequence between the pseudo signal processor unit 20P and the radio unit 10. Therefore, if the pseudo radio unit 10P executes the startup sequence based on the sequence log generated by the pseudo signal processor unit 20P, the operation of the pseudo radio unit 10P will be the same or almost the same as the operation of the radio unit 10, that is, the pseudo radio unit 10P can simulate the behavior of the radio unit 10 with good accuracy. Therefore, without directly connecting the signal processor unit 20 and the radio unit 10, the operation of the signal processor unit 20 may be accurately verified using the pseudo radio unit 10P.

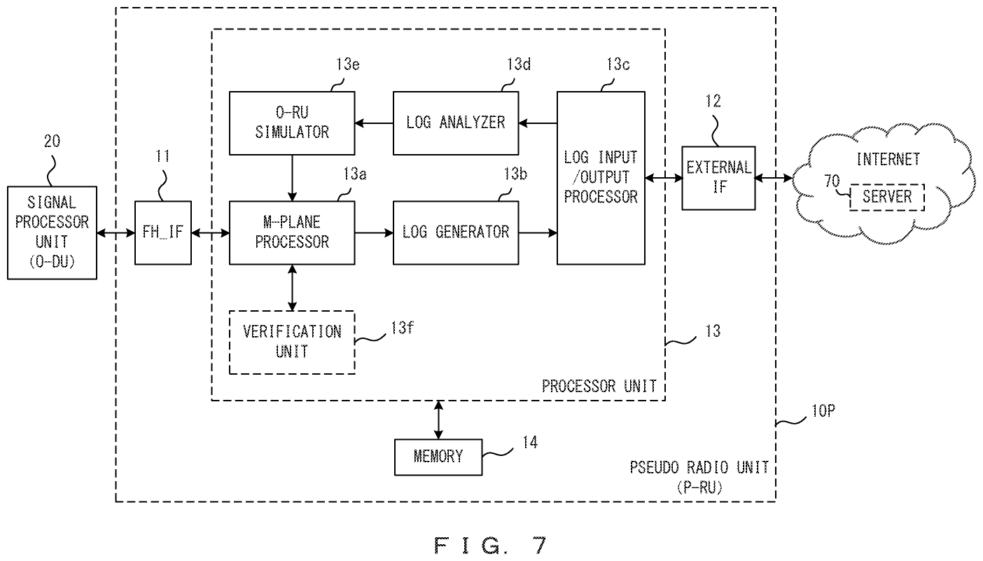

FIG. 7 illustrates an example of the pseudo radio unit (P-RU) 10P. The pseudo radio unit 10P is equipped with a fronthaul interface 11, an external interface 12, a processor 13, and a memory 14. Meanwhile, the pseudo radio unit 10P may also be equipped with other circuits or elements that are not illustrated in FIG. 7.

The fronthaul interface 11 provides the interface between the pseudo radio unit 10P and the signal processor unit (O-DU) 20. The fronthaul interface 11 is implemented by, for example, eCPRI. The external interface 12 provides the interface between the pseudo radio unit 10P and the network.

The processor 13 includes an M-plane processor 13a, a log generator 13b, a log input/output processor 13c, a log analyzer 13d, an O-RU simulator 13e, and a verification unit 13f. The processor 13 may also be equipped with other functions that are not illustrated in FIG. 7.

The M-plane processor 13a processes the M-plane signals. That is, the M-plane processor 13a generates M-plane signals to be transmitted to the signal processor unit 20 and processes M-plane signals received from the signal processor unit 20. As an example, the M-plane processor 13a can execute the startup sequence illustrated in FIG. 4 in conjunction with the signal processor unit 20. The log generator 13b generates a sequence log that indicates the signal processing between the M-plane processor 13a and the signal processor unit 20.

The log input/output processor 13c transmits the sequence log generated by the log generator 13b to a specified destination. For example, the sequence log is transmitted to the pseudo signal processor unit 20P or the server 70. Also, the log input/output processor 13c receives the sequence log generated by the pseudo signal processor unit 20P via the Internet. Alternatively, the log input/output processor 13c may acquire the sequence log generated by the pseudo signal processor unit 20P from the server 70.

The log analyzer 13d analyzes the sequence log generated by the pseudo signal processor unit 20P. For example, the log analyzer 13d detects the type of message transmitted or received by the pseudo signal processor unit 20P, and also detects the time when the pseudo signal processor unit 20P transmitted or received the message.

The O-RU simulator 13e controls the M-plane processor 13a based on the result of the analysis by the log analyzer 13d. Specifically, the O-RU simulator 13e controls the M-plane processor 13a so that the M-plane processor 13a operates based on the sequence log generated by the pseudo signal processor unit 20P. Accordingly, the M-plane processor 13a can simulate the operation of the radio unit (O-RU) 10 with good accuracy.

The verification unit 13f verifies the operation of the signal processor unit 20 based on the result of the execution by the M-plane processor 13a. Specifically, the operation of the signal processor unit 20 is verified based on the execution result at the time when the M-plane processor 13a operates based on the sequence log generated by the pseudo signal processor unit 20P. Note that the pseudo radio unit 10P does not have to be equipped with the verification unit 13f. That is, the verification of the operation of the signal processor unit 20 may be performed by any information processing device that acquires the result of the execution by the M-plane processor 13a.

The processor 13 is realized by a processor such as a CPU, for example. In this case, the processor executes a software program to provide the functions of the M-plane processor 13a, the log generator 13b, the log input/output processor 13c, the log analyzer 13d, the O-RU simulator 13e, and the verification unit 13f. However, the processor 13 may be realized by a hardware circuit or may be realized by a combination of software and a hardware circuit.

The memory 14 stores the program to be executed by the processor 13. Also, the memory 14 stores data generated by the processor 13. For example, the sequence log is temporarily stored in the memory 14.

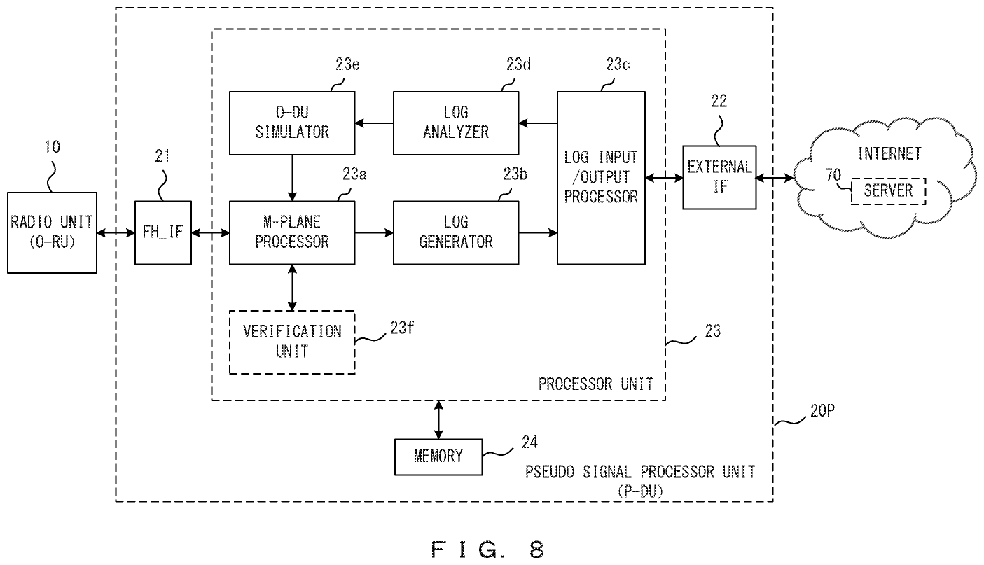

FIG. 8 illustrates an example of the pseudo signal processor unit (P-DU) 20P. The pseudo signal processor unit 20P is equipped with a fronthaul interface 21, an external interface 22, a processor 23, and a memory 24. The pseudo signal processor unit 20P may also be equipped with other circuits or elements that are not illustrated in FIG. 8.

The configuration of the pseudo signal processor unit 20P is mostly the same as the pseudo radio unit 10P illustrated in FIG. 7. However, while the pseudo radio unit 10P is connected to the signal processor unit (O-DU) 20, the pseudo signal processor unit 20P is connected to the radio unit (O-RU) 10.

The fronthaul interface 21 provides an interface between the pseudo signal processor unit 20P and the radio unit 10. The fronthaul interface 21 is implemented by eCPRI, for example, in a similar manner to the fronthaul interface 11. The external interface 22 provides the interface between the pseudo signal processor unit 20P and the network.

The processor 23 includes an M-plane processor 23a, a log generator 23b, a log input/output processor 23c, a log analyzer 23d, an O-DU simulator 23e, and a verification unit 23f. Meanwhile, the processor 23 may also be equipped with other functions that are not illustrated in FIG. 8.

The M-plane processor 23a processes the M-plane signals. That is, it generates M-plane signals to be transmitted to the radio unit 10 and processes M-plane signals received from the radio unit 10. As an example, the M-plane processor 23a can execute the startup sequence illustrated in FIG. 4 in conjunction with the radio unit 10. The log generator 23b generates a sequence log that indicates the signal processing between the M-plane processor 23a and the radio unit 10.

The log input/output processor 23c transmits the sequence log generated by the log generator 23b to a specified destination. For example, the sequence log is transmitted to the pseudo radio unit 10P or the server 70. Also, the log input/output processor 23c receives the sequence log generated by the pseudo radio unit 10P via the Internet. Alternatively, the log input/output processor 23c may acquire the sequence log generated by the pseudo radio unit 10P from the server 70.

The log analyzer 23d analyzes the sequence log generated by the pseudo radio unit 10P. For example, the log analyzer 23d detects the type of message transmitted or received by the pseudo radio unit 10P, and also detects the time when the pseudo radio unit 10P transmitted or received the message.

The O-DU simulator 23e controls the M-plane processor 23a based on the result of the analysis by the log analyzer 23d. Specifically, the O-DU simulator 23e controls the M-plane processor 23a so that the M-plane processor 23a operates based on the sequence log generated by the pseudo radio unit 10P. Accordingly, the M-plane processor 23a can simulate the operation of the signal processor unit (O-DU) 20.

The verification unit 23f verifies the operation of the radio unit 10 based on the result of the execution by the M-plane processor 23a. Specifically, the operation of the radio unit 10 is verified based on the execution result at the time when the M-plane processor 23a operates based on the sequence log generated by the pseudo radio unit 10P. Meanwhile, the pseudo signal processor unit 20P does not have to be equipped with the verification unit 23f. That is, the verification of the operation of the radio unit 10 may be performed by any information processing unit that acquires the result of the execution of the M-plane processor 23a.

The processor 23 is realized by a processor such as a CPU, for example. In this case, the processor executes a software program to provide the functions of the M-plane processor 23a, the log generator 23b, the log input/output processor 23c, the log analyzer 23d, the O-DU simulator 23e, and the verification unit 23f. However, the processor 23 may be realized by a hardware circuit or may be realized by a combination of software and a hardware circuit.

The memory 24 stores the program to be executed by the processor 23. Also, the memory 24 stores data generated by the processor 23. For example, the sequence log is temporarily stored in the memory 24.

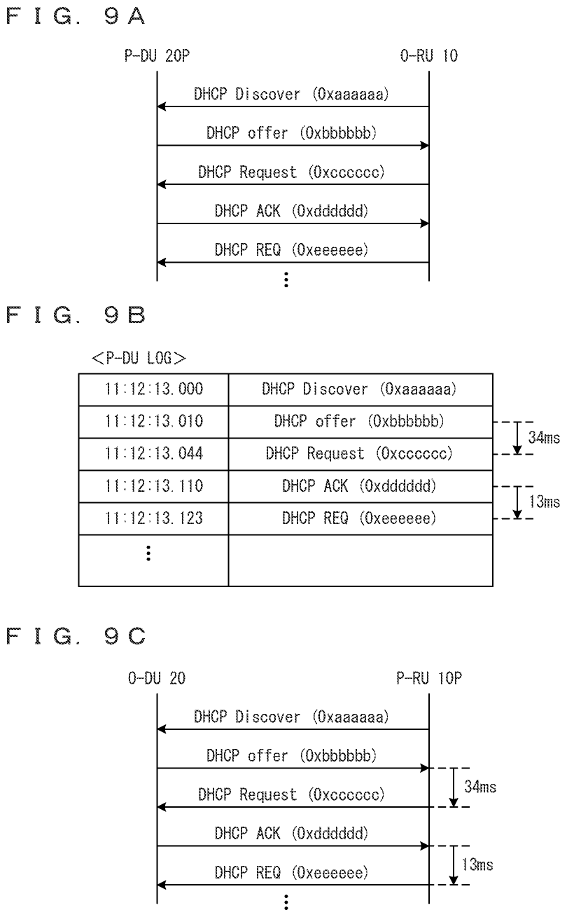

FIGS. 9A-9C illustrate an example of a method for verifying the operation of the signal processor unit (O-DU) 20. When verifying the operation of the signal processor unit 20, the pseudo radio unit (P-RU) 10P is connected to the signal processor unit 20. However, in order to increase the simulation accuracy of the pseudo radio unit 10P, first, as illustrated in FIG. 9A, an M-plane connection sequence (for example, the startup sequence illustrated in FIG. 4) is executed between the pseudo signal processor unit (P-DU) 20P and the radio unit (O-RU) 10. Then, a sequence log is generated by the pseudo signal processor unit 20P. In the following description, the sequence log generated by the pseudo signal processor unit 20P may be referred to as the “P-DU log.”

In this example, the radio unit 10 transmits a DHCP Discover at time 11:12:13.000. The pseudo signal processor unit 20P transmits a DHCP offer at time 11:12:13.010 in response to the DHCP Discover. The radio unit 10 transmits a DHCP Request at time 11:12:13.044 in response to the DHCP offer. The pseudo signal processor unit 20P transmits a DHCP_ACK at time 11:12:13.110 in response to the DHCP Request. The radio unit 10 transmits DHCP_REQ at time 11:12:13.123 in response to the DHCP_ACK. The subsequent procedure is omitted. In this case, the P-DU log presented in FIG. 9B is generated.

The pseudo radio unit 10P acquired the P-DU log generated by the pseudo signal processor unit 20P. Then, the log analyzer 13d analyzes the P-DU log. That is, the log analyzer 13d extracts, from the P-DU log, the messages transmitted by the radio unit 10. In this example, DHCP Discover, DHCP Request and DHCP_REQ are extracted. In addition, the log analyzer 13d calculates, in the P-DU log, the response time of the radio unit 10. Specifically, the difference is calculated between the time when the radio unit received a message and the time when the radio unit 10 transmitted the corresponding message. In this example, the difference “34 milliseconds” is calculated between the time when the radio unit 10 received the DHCP offer and the time when the radio unit 10 transmitted the DHCP Request. Also, the difference “13 milliseconds” is calculated between the time at which the radio unit 10 received the DHCP_ACK and the time at which the radio unit 10 transmitted the DHCP_REQ.

The O-RU simulator 13e controls the M-plane processor 13a based on the result of the analysis by the log analyzer 13d. That is, the O-RU simulator 13e controls the M-plane processor 13a so that the M-plane connection sequence that was actually executed by the radio unit 10 is reproduced. In this example, the M-plane processor 13a performs the following operations in response to the instruction from the O-RU simulator 13e.

(1) The M-plane processor 13a transmits a DHCP Discover to the signal processor unit 20.
(2) The M-plane processor 13a transmits, 34 milliseconds after receiving the DHCP offer from the signal processor unit 20, a DHCP Request to the signal processor unit 20.
(3) The M-plane processor 13a transmits, 13 milliseconds after receiving the DHCP_ACK from the signal processor unit 20, a DHCP_REQ to the signal processor unit 20.

Meanwhile, in FIG. 9A or 9C, only a part of step S1 illustrated in FIG. 4 is presented, but in practice, it is preferable to execute the whole startup sequence illustrated in FIG. 4. Then, the verification unit 13f verifies the operation of the signal processor unit 20 based on whether or not the startup sequence has been successfully completed. For example, if the startup sequence is successfully completed, the verification unit 13f determines that the signal processor unit 20 is normal. Alternatively, when the pseudo radio unit 10P is not equipped with the verification unit 13f, the operator who verifies the operation of the signal processor unit 20 may determine whether or not the startup sequence has been successfully completed.

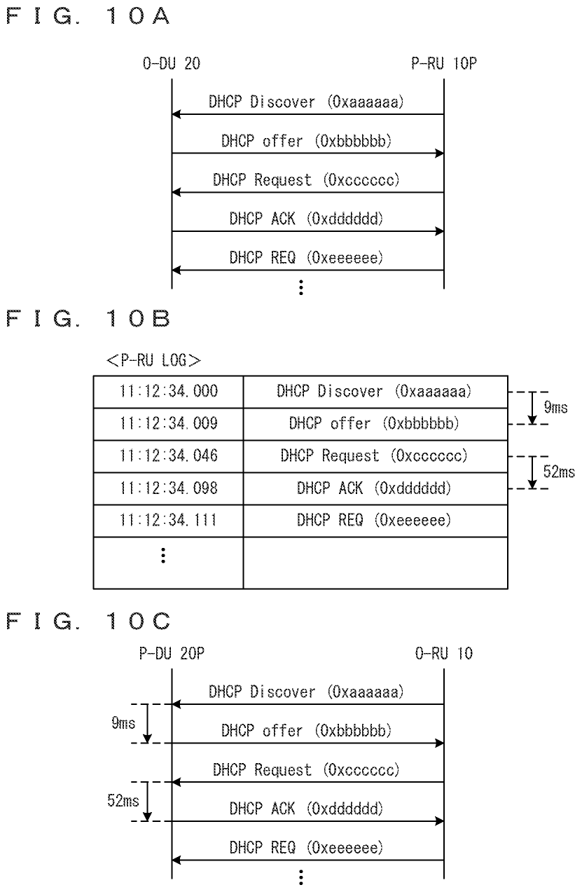

FIGS. 10A-10C illustrate an example of a method for verifying the operation of the radio unit (O-RU) 10. The method for verifying the operation of the radio unit 10 is almost identical to the method for verifying the operation of the signal processor unit 20 described in FIGS. 9A-9C. That is, when verifying the operation of the radio unit 10, the pseudo signal processor unit (P-DU) 20P is connected to the radio unit 10. However, in order to increase the simulation accuracy of the pseudo signal processor unit 20P, first, as illustrated in FIG. 10A, an M-plane connection sequence (for example, the startup sequence illustrated in FIG. 4) is executed between the pseudo radio unit (P-RU) 10P and the signal processor unit (O-DU) 20. Then, a sequence log is generated by the pseudo radio unit 10P. In the following description, the sequence log generated by the pseudo radio unit 10P may be referred to as the “P-RU log”.

In this example, the pseudo radio unit 10P transmits a DHCP Discover at time 11:12:34.000. The signal processor unit 20 transmits a DHCP offer at time 11:12:34.009 in response to the DHCP Discover. The pseudo radio unit 10P transmits a DHCP Request at time 11:12:34.046 in response to the DHCP offer. The signal processor unit 20 transmits a DHCP_ACK at time 11:12:34.098 in response to the DHCP Request. The pseudo radio unit 10P transmits a DHCP_REQ at time 11:12:34.111 in response to the DHCP_ACK. The subsequent procedure is omitted. In this case, the P-RU log presented in FIG. 10B is generated.

The pseudo signal processor unit 20P acquires the P-RU log generated by the pseudo radio unit 10P. Then, the log analyzer 23d analyzes the P-RU log. That is, the log analyzer 23d extracts, from the P-RU log, the message transmitted by the signal processor unit 20. In this example, DHCP offer and DHCP_ACK are extracted. In addition, the log analyzer 23d calculates, in the P-RU log, the response time of the signal processor unit 20. Specifically, the log analyzer 23d calculates the response time of the signal processor unit 20 in the P-RU log. Specifically, the difference is calculated between the time the signal processor unit 20 received the message and the time the signal processor unit 20 transmitted the corresponding message. In this example, the difference “9 milliseconds” is calculated between the time when the signal processor unit 20 received the DHCP Discover and the time when the signal processor unit 20 transmitted the DHCP offer. Also, the difference “52 milliseconds” is calculated between the time when the signal processor unit 20 received the DHCP Request and the time when the signal processor unit 20 transmitted the DHCP_ACK.

The O-DU simulator 23e controls the M-plane processor 23a based on the result of the analysis by the log analyzer 23d. That is, the O-DU simulator 23e controls the M-plane processor 23a so that the M-plane connection sequence that was actually executed by the signal processor unit 20 is reproduced. In this example, the M-plane processor 23a performs the following operations in response to the instruction from the O-DU simulator 23e.

(1) The M-plane processor 23a transmits, 9 milliseconds after receiving the DHCP Discover message from the radio unit 10, a DHCP offer to the radio unit 10.
(2) The M-plane processor 23a transmits, 52 milliseconds after receiving the DHCP Request from the radio unit 10, a DHCP_ACK to the radio unit 10.

Meanwhile, in FIG. 10A or 10C, only a part of step S1 illustrated in FIG. 4 is presented, but in practice, it is preferable to execute the whole startup sequence illustrated in FIG. 4. Then, the verification unit 33f verifies the operation of the radio unit 10 based on whether or not the startup sequence has been completed successfully. For example, if the startup sequence is successfully completed, the verification unit 33f determines that the radio unit 10 is normal. Alternatively, if the pseudo signal processor unit 20P is not equipped with the verification unit 23f, the operator who verifies the operation of the radio unit 10 may determine whether or not the startup sequence is successfully completed.

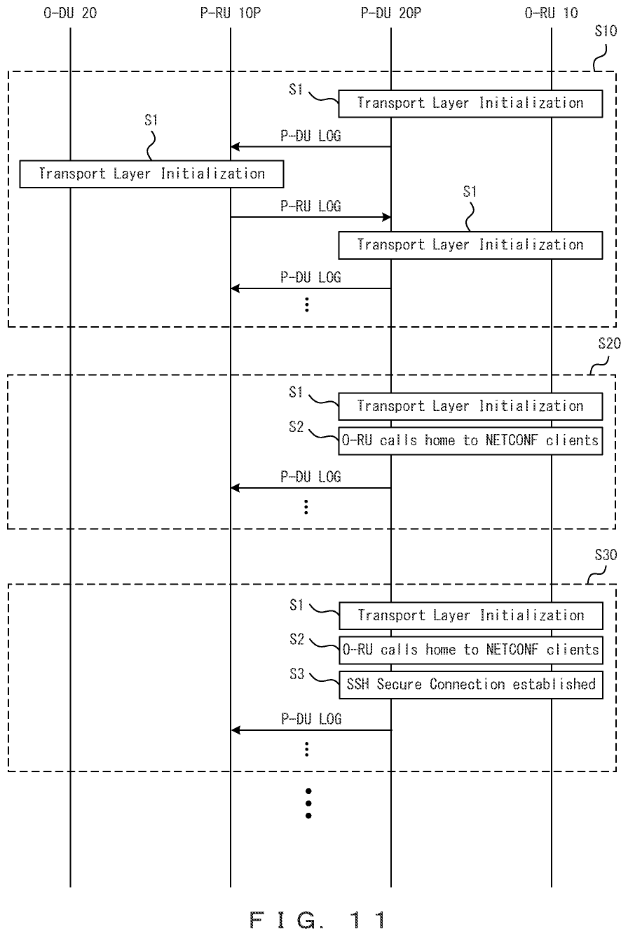

FIG. 11 illustrates an example of the operation of the verification system 1. In this example, the pseudo radio unit (P-RU) 10P and the pseudo signal processor unit (P-DU) 20P respectively verify the operation of the signal processor unit (O-DU) 20 and the radio unit (O-RU) 10 by executing the startup sequence illustrated in FIG. 4.

In S10, the pseudo radio unit 10P and the pseudo signal processor unit 20P execute S1 (Transport Layer Initialization) of the startup sequence illustrated in FIG. 4. That is, the pseudo radio unit 10P executes the process of S1 process in conjunction with the signal processor unit 20. Meanwhile, the pseudo signal processor unit 20P executes the process of S1 in conjunction with the radio unit 10.

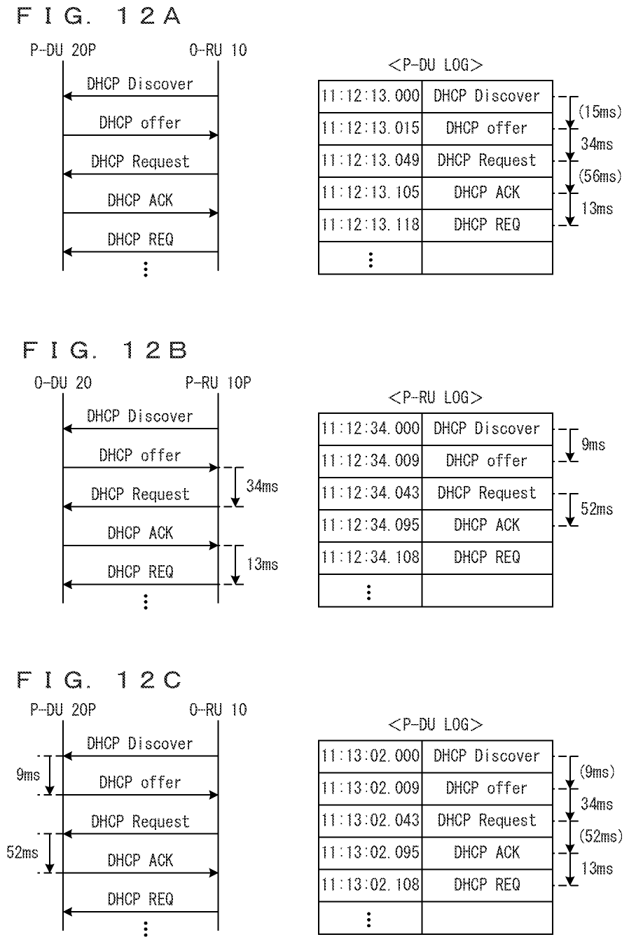

FIGS. 12A-12C illustrate an example of S10 in FIG. 11. In this example, first, the pseudo signal processor unit 20P and the radio unit 10 execute the process of S1 as illustrated in FIG. 11 and FIG. 12A. It is assumed that, at this time, the following operations are performed.

(1) The radio unit 10 transmits a DHCP discover.
(2) The pseudo signal processor unit 20P transmits a DHCP offer 15 milliseconds after receiving the DHCP Discover.
(3) The radio unit 10 transmits a DHCP Request 34 milliseconds after receiving the DHCP offer.
(4) The pseudo signal processor unit 20P transmits a DHCP_ACK 56 milliseconds after receiving the DHCP Request.
(5) The radio unit 10 transmits a DHCP REC 13 milliseconds after receiving the DHCP_ACK.
At this time, the pseudo signal processor unit 20P generates the P-DU log illustrated in FIG. 12A.

The pseudo radio unit 10P acquires this P-DU log. Then, the pseudo radio unit 10P analyzes the acquired P-DU log to generate RU operation information indicating the operations that were actually performed by the radio unit 10. Specifically, the following RU operation information is generated.

(1) The radio unit transmits a DHCP Request 34 milliseconds after receiving the DHCP offer.
(2) The radio unit transmits a DHCP REC 13 milliseconds after receiving the DHCP_ACK.

Then, the pseudo radio unit 10P operates according to the RU operation information. That is, the pseudo radio unit 10P transmits messages at the timing illustrated in FIG. 12B. It is assumed that, as a result, the following operations are performed.

(1) The pseudo radio unit 10P transmits a DHCP Discover.
(2) The signal processor unit 20 transmits a DHCP offer 9 milliseconds after receiving the DHCP Discover.
(3) The pseudo radio unit 10P transmits a DHCP Request 34 milliseconds after receiving the DHCP offer.
(4) The signal processor unit 20 transmits a DHCP_ACK 52 milliseconds after receiving the DHCP Request.
(5) The pseudo radio unit 10P transmits a DHCP REC 13 milliseconds after receiving the DHCP_ACK.
At this time, the pseudo radio unit 10P generates the P-RU log illustrated in FIG. 12B.

The pseudo signal processor unit 20P acquires this P-RU log. Then, the pseudo signal processor unit 20P generates DU operation information indicating the operations that were actually performed by the signal processor unit 20 by analyzing the acquired P-RU log. Specifically, the following DU operation information is generated.

(1) The signal processor unit transmits a DHCP offer 9 milliseconds after receiving the DHCP Discover.
(2) The signal processor unit transmits a DHCP_ACK 52 milliseconds after receiving the DHCP Request.

Then, the pseudo signal processor unit 20P transmits messages at the timing illustrated in FIG. 12C. It is assumed that, as a result, the following operations are performed.

(1) The radio unit 10 transmits a DHCP Discover.
(2) The pseudo signal processor unit 20P transmits a DHCP offer 9 milliseconds after receiving the DHCP Discover.
(3) The radio unit 10 transmits a DHCP Request 34 milliseconds after receiving the DHCP offer.
(4) The pseudo signal processor unit 20P transmits a DHCP_ACK 52 milliseconds after receiving the DHCP Request.
(5) The radio unit 10 transmits a DHCP REC 13 milliseconds after receiving the DHCP_ACK.

Next, the pseudo signal processor unit 20P verifies the operation of the radio unit 10. Specifically, the pseudo signal processor unit 20P compares the newly detected response time of the radio unit 10 with the response time of the radio unit 10 detected in the previous sequence. If these response times match or approximate match each other, it is determined that the pseudo radio unit 10P is simulating the radio unit 10 with good accuracy, and the pseudo signal processor unit 20P is simulating the signal processor unit 20 with good accuracy. In the example illustrated in FIGS. 12A-12C, the determination is made as follows. That is, in the sequence in FIG. 12A, the response time counting from the time the radio unit 10 received the DHCP offer to the time it transmitted the DHCP Request is 34 milliseconds, and the response time counting from the time the radio unit 10 received the DHCP_ACK to the time it transmitted the DHCP_REQ is 13 milliseconds. Meanwhile, in the sequence in FIG. 12C, the response time counting from the time the radio unit 10 received the DHCP offer to the time it transmitted the DHCP Request is 34 milliseconds, and the response time counting from the time the radio unit 10 received the DHCP_ACK to the time it transmitted the DHCP_REQ is 13 milliseconds. Therefore, in this case, it is determined that the pseudo radio unit 10P is simulating the radio unit 10 with good accuracy, and the pseudo signal processor unit 20P is simulating the signal processor unit 20 with good accuracy.

Note that, at the stage illustrated in FIG. 12A, the pseudo signal processor unit 20P may not be accurately simulating the operation of the signal processor unit 20. However, the pseudo radio unit 10P and the pseudo signal processor unit 20P exchange sequence logs and respectively execute the startup sequence based on the corresponding sequence logs. Therefore, it is considered that at the stage illustrated in FIG. 12C, the pseudo radio unit 10P accurately simulates the operation of the radio unit 10, and the pseudo signal processor unit 20P accurately simulates the operation of the signal processor unit 20.

When the difference between the newly detected response time and the response time detected in the previous sequence is larger than a prescribed threshold, the pseudo radio unit 10P and the pseudo signal processor unit 20P continue the process of S10 illustrated in FIG. 11. That is, the sequence logs are exchanged between the pseudo radio unit 10P and the pseudo signal processor unit 20P, and the pseudo radio unit 10P and the pseudo signal processor unit 20P respectively execute the startup sequence based on the corresponding sequence logs. Then, when the difference in the response time has become smaller than the threshold, it is determined that the simulation accuracy has become sufficiently high.

When the simulation accuracy is sufficiently high for the operations in S1, the pseudo radio unit 10P and the pseudo signal processor unit 20P execute S20 illustrated in FIG. 11. Here, S20 corresponds to S1 through S2 of the startup sequence illustrated in FIG. 4. Then, the pseudo radio unit 10P and the pseudo signal processor unit 20P adjust the timing of message transmission so that the simulation accuracy becomes high, in a similar manner as in S10.

When the simulation accuracy is sufficiently high with respect to the operations in S1 through S2, the pseudo radio unit 10P and the pseudo signal processor unit 20P execute S30 illustrated in FIG. 11. Here, S30 corresponds to S1 through S3 of the startup sequence illustrated in FIG. 4. Then, the pseudo radio unit 10P and the pseudo signal processor unit 20P adjust the timing of message transmission so that the pseudo accuracy becomes high, in a similar way as in S10 or S20.

In a similar manner, the pseudo radio unit 10P and the pseudo signal processor unit 20P adjust the timing of message transmission so that the simulation accuracy becomes high while gradually increasing the amount of steps to be executed. As a result, the pseudo radio unit 10P and the pseudo signal processor unit 20P are adjusted for the entire startup sequence illustrated in FIG. 4. That is, for the entire startup sequence illustrated in FIG. 4, the pseudo radio unit 10P is adjusted to a state in which the pseudo radio unit 10P can simulate the pseudo the radio unit 10 with good accuracy, and the pseudo signal processor unit 20P is adjusted to a state in which the pseudo signal processor unit 20P can simulate the pseudo the signal processor unit 20 with good accuracy. In other words, the pseudo radio unit 10P can reproduce the operation of the radio unit 10 with good accuracy, and the pseudo signal processor unit 20P can reproduce the operation of the signal processor unit 20 with good accuracy. Therefore, without directly connecting the signal processor unit 20 and the radio unit 10, the pseudo radio unit 10P can verify the operation of the signal processor unit 20 with good accuracy, and the pseudo signal processor unit 20P can verify the operation of the radio unit 10 with good accuracy.

Meanwhile, in the above example, the pseudo signal processor unit 20P operates as the master device and the sequence between the pseudo signal processor unit 20P and the radio unit 10 is executed first, but the present invention is not limited to this configuration. That is, the pseudo radio unit 10P may function as the master device and the sequence between the pseudo radio unit 10P and the signal processor unit 20 may be executed first.

Also, the pseudo radio unit 10P and/or the pseudo signal processor unit 20P do not have to verify the operation of the signal processor unit 20 and/or the radio unit 10. For example, the pseudo radio unit 10P and the pseudo signal processor unit 20P execute the startup sequence in the manner illustrated in in FIG. 11. Then, a test administrator may verify the signal processor unit 20 or the radio unit 10 depending on whether or not the startup sequence is executed to the end.

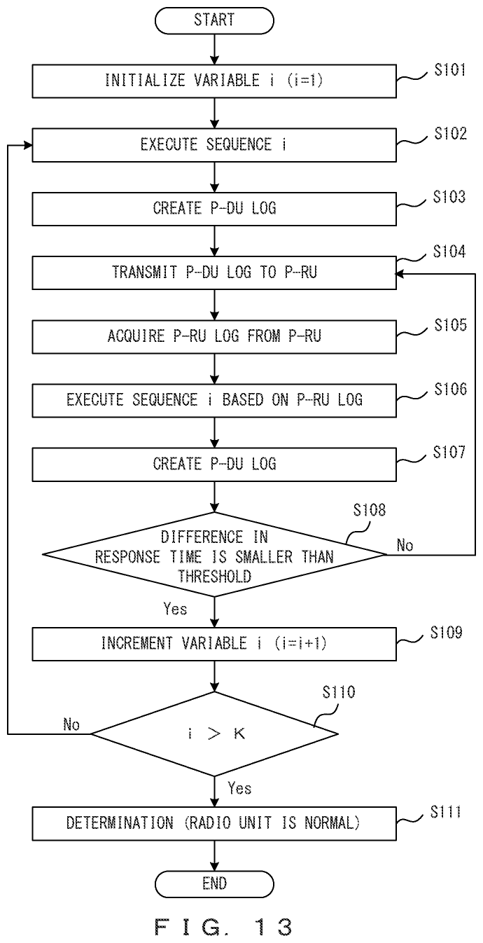

FIG. 13 is a flowchart illustrating an example of the processing of the pseudo signal processor unit (P-DU) 20P. In this example, the pseudo signal processor unit 20P is connected to the radio unit (O-RU) 10. Meanwhile, the pseudo radio unit (P-RU) 10P is connected to the signal processing unit (O-DU) 20.

In S101, the pseudo signal processor unit 20P initializes the variable i to 1. The variable i identifies each sequence of the M-plane connection sequence. In the example illustrated in FIG. 11, S10, S20, and S30 each correspond to one sequence i (i=1, 2, 3 . . . ).

In S102 through S103, the pseudo signal processor unit 20P executes the sequence i and creates a P-DU log. In S104, the pseudo signal processor unit 20P transmits the P-DU log to the pseudo radio unit 10P. Meanwhile, it is assumed that S104 includes a case in which the pseudo signal processor unit 20P transmits the P-DU log to the server 70 and the pseudo radio unit 10 acquires the P-DU log from the server 70.

In S105, the pseudo signal processor unit 20P acquires the P-RU log from the pseudo radio unit 10P. Here, it is assumed that the pseudo radio unit 10P executes the sequence i with the signal processor unit 20 based on the P-DU log created in S103. Note that the P-RU log indicates the result of the execution of the sequence i by the pseudo radio unit 10P.

In S106 through S107, the pseudo signal processor unit 20P executes the sequence i based on the acquired P-RU log and creates a P-DU log that represents the result of the execution. In S108, the pseudo signal processor unit 20P calculates the difference between the response time of the radio unit 10 calculated from the log acquired in S103 and the response time of the radio unit 10 calculated from the log acquired in S107. Then, when the pseudo signal processor unit 20P compares the difference with a prescribed threshold. The threshold is a value that is sufficiently small. Then, when the difference in the response time is larger than the threshold, the processing of the pseudo signal processor unit 20P returns to S104. That is, the processes of S104 through S108 are repeatedly executed until the difference in the response time becomes smaller than the threshold.

When the difference in the response time becomes smaller than the threshold, the pseudo signal processor unit 20P determines that the pseudo radio unit 10P is simulating the radio unit 10 with good accuracy and the pseudo signal processor unit 20P is simulating the signal processor unit 20 with good accuracy. In this case, in S109, the pseudo signal processor unit 20P increments the variable i. That is, the next sequence is executed. For example, when S10 illustrated in FIG. 11 is executed in S102 through S108, the pseudo signal processor unit 20P transitions to a state for executing S20.

In S110, the pseudo signal processor unit 20P determines whether or not the variable i is larger than a prescribed value K. The prescribed value K represents the number of sequences constituting the M-plane connection sequence. That is, in S110, it is determined whether or not there is any remaining sequence for which the processes of S102 through S108 have not been executed. Then, when the variable i is equal to or smaller than the prescribed value K, the processing of the pseudo signal processor unit 20P returns to S102. That is, the pseudo signal processor unit 20P executes the processes of S102 through S108 for all the sequences constituting the M-plane connection sequence.

When all the sequences constituting the M-plane connection sequence have been completed, it is considered that the pseudo radio unit 10P and the pseudo signal processor unit 20P have been respectively adjusted to a state in which the operations of the radio unit 10 and the signal processor unit 20 may be reproduced. That is, when the M-plane connection sequence is completed between the pseudo signal processor unit 20P and the radio unit 10, it is considered that M-plane connection sequence is completed between the signal processor unit 20 and the radio unit 10. Therefore, without directly connecting the signal processor unit 20 and the radio unit 10, the operation of the radio unit 10 may be verified with good accuracy using the pseudo signal processor unit 20P.

Meanwhile, when the M-plane connection sequence is not completed, it is estimated that there is an abnormality in the radio unit 10 (or the signal processor unit 20). For example, when the difference in the response time does not become smaller than the threshold in the sequence j, it may be determined that the radio unit 10 (or the signal processor unit 20) fails to execute the sequence j in the normal manner. In this case, it becomes possible for the test administrator to recognize which function of the radio unit 10 (or the signal processor unit 20) should be corrected.

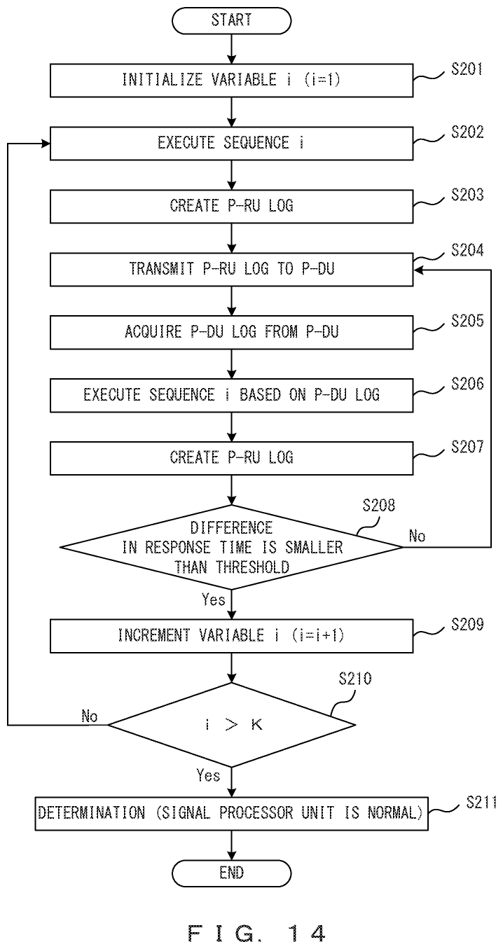

FIG. 14 is a flowchart illustrating an example of the processing of the pseudo radio unit (P-RU) 10P. The process (S201 through S211) of the pseudo radio unit 10P is substantially the same as the process (S101 through S111) of the pseudo signal processor unit 20P illustrated in FIG. 13. However, the pseudo radio unit 10P executes the connection process with the signal processor unit 20 based on the sequence log acquired from the pseudo signal processor unit 20P.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A verification system that verifies a connection between a signal processor unit of a radio base station and a radio unit of a radio base station, the verification system comprising:
a pseudo radio unit connected to the signal processor unit; and
a pseudo signal processor unit connected to the radio unit, wherein
the pseudo radio unit includes a first processor configured to
execute a connection sequence with the signal processor unit,
acquire a first sequence log that indicates an execution result of a connection sequence between the pseudo signal processor unit and the radio unit, and
execute a connection sequence with the signal processor unit based on the first sequence log, and
the pseudo signal processor unit includes a second processor configured to
execute a connection sequence with the radio unit,
acquire a second sequence log that indicates an execution result of a connection sequence between the pseudo radio unit and the signal processor unit, and
execute a connection sequence with the radio unit based on the second sequence log.

2. The verification system according to claim 1, wherein
when a connection sequence that the first processor executes with the signal processor unit based on the first sequence log is completed, it is determined that the signal processor unit is normal, and
when a connection sequence that the second processor executes with the radio unit based on the second sequence log is completed, it is determined that the radio unit is normal.

3. The verification system according to claim 1, wherein
the first processor analyzes the first sequence log to calculate a response time of the radio unit, and
the first processor executes a connection sequence with the signal processor unit using the response time of the radio unit.

4. The verification system according to claim 1, wherein
the second processor analyzes the second sequence log to calculate a response time of the signal processor unit, and
the second processor executes a connection sequence with the radio unit using the response time of the signal processor unit.

5. The verification system according to claim 1, wherein
the first processor analyzes the first sequence log to calculate a response time of the radio unit,
the second processor analyzes the second sequence log to calculate a response time of the signal processor unit, and
a first process in which the first processor executes a connection sequence with the signal processor unit based on the first sequence log and generates the second sequence log and a second process in which the second processor executes a connection sequence with the radio unit based on the second sequence log and generates the first sequence log are alternately repeated until a response time of the radio unit or a response time of the signal processor unit converges.

6. A verification device that verifies a signal processor unit of a radio base station, the verification device comprising:
a processor configured to
execute a connection sequence with the signal processor unit,
acquire a sequence log that indicates an execution result of a connection sequence between a pseudo signal processor unit and a radio unit of a radio base station, and
execute a connection sequence with the signal processor unit based on the sequence log.

7. A verification device that verifies a radio unit of a radio base station, the verification device comprising:
a processor configured to
execute a connection sequence with the radio unit,
acquire a sequence log that indicates an execution result of a connection sequence between a pseudo radio unit and a signal processor unit of a radio base station, and
execute a connection sequence with the radio unit based on the sequence log.
